(19) United States
(12) Patent Application Publication
(10) Pub. No.: US 2014/0153929 A1
(43) Pub. Date: Jun. 5, 2014

(54) Single Sideband Up-Down Converter for Sub-Octave Bandwidth Transmission of Low Frequency Signals

(71) Applicant: Titan Photonics, Inc., Fremont, CA (US)

(72) Inventors: Chen-Kuo Sun, Escondido, CA (US); Paul N. Huntley, Poway, CA (US)

(73) Assignee: Titan Photonics, Inc., Fremont, CA (US)

(21) Appl. No.: 14/157,263

(22) Filed: Jan. 16, 2014

Related U.S. Application Data
(63) Continuation-in-part of application No. 13/645,292, filed on Oct. 4, 2012.
Application No. 13/645,292 is a continuation-in-part of application No. 13/585,653, filed on Aug. 14, 2012.

(51) Int. Cl. H04B 10/516; H04B 10/2575; H04B 10/2507

(52) U.S. Cl. CPC H04B 10/5165; H04B 10/25073; H04B 10/2575
USPC 398/115

(57) ABSTRACT

A system for transporting a plurality of relatively low-frequency information signals over an optical fiber can include a plurality of transmitters. Each transmitter receives one of the relatively low-frequency information signals as an input, processes the input signal, and outputs an up-shifted (i.e. relatively high frequency) signal that has a suppressed sideband to reduce transmission power requirements. Sideband suppression is accomplished using a technique in which a first component of the input signal is shifted in phase by 180 degrees and summed with a second, in-phase signal component. The signals output from the transmitters are then frequency stacked and the resulting signal is converted to an optical signal for transmission over an optical fiber. The up-shifted signals output from the transmitters have frequencies within a single sub-octave frequency band to reduce the adverse effects of composite second order distortions that can occur during optical transport of the information signals.

This application is a continuation-in-part of application Ser. No. 13/645,292, filed Oct. 4, 2012, which is a continuation-in-part of application Ser. No. 13/585,653, filed Aug. 14, 2012, both of which are currently pending. The contents of application Ser. No. 13/585,653 and application Ser. No. 13/645,292 are hereby incorporated herein by reference.

### FIELD OF THE INVENTION

The present invention pertains generally to systems and methods for transporting telecommunication signals using an optical fiber. More particularly, the present invention pertains to systems and methods for simultaneously transporting a plurality of telecommunication signals over an optical fiber with reduced second order distortions. The present invention is particularly, but not exclusively, useful for up-shifting information signals onto carrier signals to produce single sideband (SSB) signals within a single sub-octave radio-frequency (RF) band, for subsequent electrical-to-optical conversion and transmission over an optical fiber.

### BACKGROUND OF THE INVENTION

Modernly, there is a need to transport digital data streams over relatively long distances using point-to-point and point-to-multipoint connections. In this regard, optical fibers can be used to transport signals over relatively long distances with relatively low signal distortion or attenuation, as compared with copper wire or co-axial cables.

One way to transport digital information across an optical fiber is to encode the digital signal on an analog carrier signal (e.g. RF signal) using a modem. Next, the RF signal can be converted into a light beam signal using an optical transmitter such as a laser diode. The converted signal can then be introduced into an end of an optical fiber. In this process, more than one light signal can be transmitted at one time. Typically, to accommodate the transport of a large volume of information, a relatively large bandwidth RF signal, having a multi-octave bandwidth, is converted and transmitted over the optical fiber. For these multi-octave optical transmissions, composite second order distortions caused by fiber dispersion can cause significant signal degradation at optical transport distances of about 1 km, or more.

In simple systems, information signals can be encoded on an RF carrier signal by modulating the carrier signal with the information signal. During this modulation process, a double sideband (DSB) signal is typically generated, with each sideband, by itself, containing all of the pertinent information from the information signal. In some cases, a band pass filter can be used to filter one of the redundant sidebands to produce a single sideband (SSB) signal. This filtering is desirable because the resulting SSB signal requires less power to transmit than the original DSB signal. Unfortunately, all DSB signals cannot be accurately filtered to produce an SSB filter. Specifically, for cases in which the information signal has a low frequency, the resulting sidebands in the modulated DSB signal are so close to each other that one of the sidebands cannot be accurately removed using standard band pass filters. In many cases, the frequency of the input signal is beyond the control of the modem designer. For these situations, the modem designer often must accommodate low frequency information signals and as a consequence, the modem is unable to produce SSB signals using band pass filters.

As indicated above, multi-octave optical transmissions can result in composite second order distortions which can adversely affect system fidelity. These composite second order distortions can occur, for example, when the two RF signals that are transported do not reside within a single, sub-octave band. One way to avoid this phenomenon is to up-shift all of the RF signals to higher frequencies such that all of the RF signal frequencies reside with a single, sub-octave band. When signal mixing is used to upshift RF signals for this purpose, DSB signals are produced. When low frequency information signals are used as inputs to the upshifting signal mixers, the resulting DSB signals can also have sidebands that are so close to each other that one of the sidebands cannot always be accurately removed using standard band pass filters.

In light of the above, it is an object of the present invention to provide a system and method for optically transporting a plurality of signals over a single optical fiber over distances greater than about 1 km with relatively high signal fidelity and relatively low transmission power requirements. Another object of the present invention is to provide a system and method for producing up-shifted, single sideband signals to reduce the adverse effects of composite second order distortions during optical transport of information signals. It is another object of the present invention to provide a system and method for producing up-shifted, single sideband signals from relatively low frequency signal inputs. Still another object of the present invention is to provide a single sideband up-down converter for sub-octave bandwidth transmission of low frequency signals that is easy to use, relatively easy to manufacture, and comparatively cost effective.

### SUMMARY OF THE INVENTION

In accordance with the present invention, a system for transporting a plurality of relatively low-frequency information signals over an optical fiber can include a plurality of transmitters. In overview, each transmitter receives one of the relatively low-frequency information signals as an input, processes the input signal, and outputs an up-shifted (i.e. relatively high frequency) signal that has a suppressed sideband. The use of signals having suppressed sidebands reduces transmission power requirements for the system.

For the present invention, the up-shifted, suppressed sideband signals output from the transmitters are then frequency stacked and the resulting signal is converted to an optical signal for transmission over an optical fiber. For the present invention, all of the up-shifted, suppressed sideband signals output from the transmitters have frequencies within a single sub-octave band of frequencies. In more quantitative terms, the single sub-octave band of frequencies is defined as the band of frequencies between a low frequency f_{L} and a high frequency f_{H}, wherein f_{H}<2f_{L}. With this restriction on transmission frequencies, the adverse effects of composite second order distortions are reduced during optical transport of the information signals.

To produce an up-shifted, suppressed sideband signal from one of the relatively low-frequency information signals, each transmitter includes a quadrature hybrid coupler. The quadrature hybrid coupler receives one of the relatively low-frequency information signals as an input signal, for example, an input signal having a frequency, f₀, that is less than about 5 MHz can be input.

The quadrature hybrid coupler, in turn, outputs a first signal in phase with the input signal at a first coupler output and a second signal 90° out of phase with the input signal at a second coupler output. These signals are then mixed with signals produced by a local oscillator (LO) subsystem. More specifically, a local oscillator subsystem is provided which produces a first LO signal that is in phase with the input signal and has frequency, f₁, with f₁>f₀ and a second LO signal having the frequency, f₁, and that is 90° out of phase with the first LO signal. For example, the LO signal can have a frequency, f₁, that is greater than about 200 MHz.

The system also includes a first mixer that is positioned downstream of the first coupler output. The first mixer receives and mixes the first LO signal with the first signal from the first coupler output (or a modified version of the first signal when an equalizer is employed (see below)) and outputs a first mixed signal. With this arrangement, the first mixed signal is in phase with the input signal. In addition, the system includes a second mixer that is positioned downstream of the second coupler output. The second mixer receives and mixes the second LO signal and the second signal from the second coupler output (or a modified version of the second signal when an equalizer is employed (see below)) and outputs a second mixed signal. With this arrangement, the second mixed signal includes a component that is in phase with the input signal and a component that is 180° out of phase with the input signal. Because of the relative phases of the first and second mixed signals, when these signals are summed, e.g. at a summer, the out-of-phase components cancel and a signal having a suppressed sideband is produced. Typically, with the above described arrangement, about 25 dB-35 dB of sideband suppression is achieved.

In one embodiment of the system, first and second equalizers are used to increase sideband suppression by adjusting the amplitude and phase of the first and second signals output from the quadrature hybrid coupler. Alternatively, or in addition to the equalizers, a band pass filter can be used to filter the output from the summer to increase sideband suppression.

At the downstream end of the optical fiber, the system can include an optical-electrical (OE) converter for receiving the optical signal and converting it to an RF signal. A de-stacking splitter can be positioned downstream of the OE converter for frequency de-stacking the plurality of up-shifted, suppressed sideband signals in the RF signal and routing each de-stacked signal to a respective receiver. Each receiver then processes one of the de-stacked signals to downshift the signal and recover the initial input signal (e.g. a signal corresponding to the information signal having a frequency, f₀). At the receiver, the down-shifting can be accomplished with an additional 25 dB-35 dB of sideband suppression, resulting in a total sideband suppression of about 50 dB-70 dB.

In more detail, each receiver can include a splitter that receives and processes one of the de-stacked signals to output a first receiver signal portion and a second receiver signal portion. For the present invention, each receiver can also include a local oscillator (LO) subsystem producing a first receiver LO signal having frequency, f₁, that is in phase with the input signal and a second receiver LO signal having frequency, f₁, that is 90° out of phase with the first receiver LO signal. For the receiver, a first receiver mixer is provided downstream of the splitter to receive the first receiver signal portion and mix it with the first receiver LO signal to produce a first receiver mixed signal. In a similar manner, a second receiver mixer is provided downstream of the splitter and mixes the second receiver signal portion from the splitter with the second receiver LO signal to produce a second receiver mixed signal.

From the receiver mixers, the first and second mixed signals are directed to a quadrature hybrid coupler, which processes the mixed signals and outputs a recovered input signal, for example, a signal corresponding to the signal input to the transmitter having frequency, f₀.

Like the transmitter, the receiver can include equalizers (between the mixers and quadrature hybrid coupler) to increase sideband suppression by adjusting the amplitude and phase of the first and second receiver mixed signals. Alternatively, or in addition to the equalizers, the receiver can include a band pass filter to filter the output from the optical-electrical (OE) converter to increase sideband suppression.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a component schematic of a system for transporting signals in accordance with the present invention;

FIG. 2 is a component schematic of an alternative embodiment of a transmitter for use in the system shown in FIG. 1; and

FIG. 3 is a component schematic of an alternative embodiment of a receiver for use in the system shown in FIG. 1.

### DESCRIPTION OF THE PREFERRED EMBODIMENTS

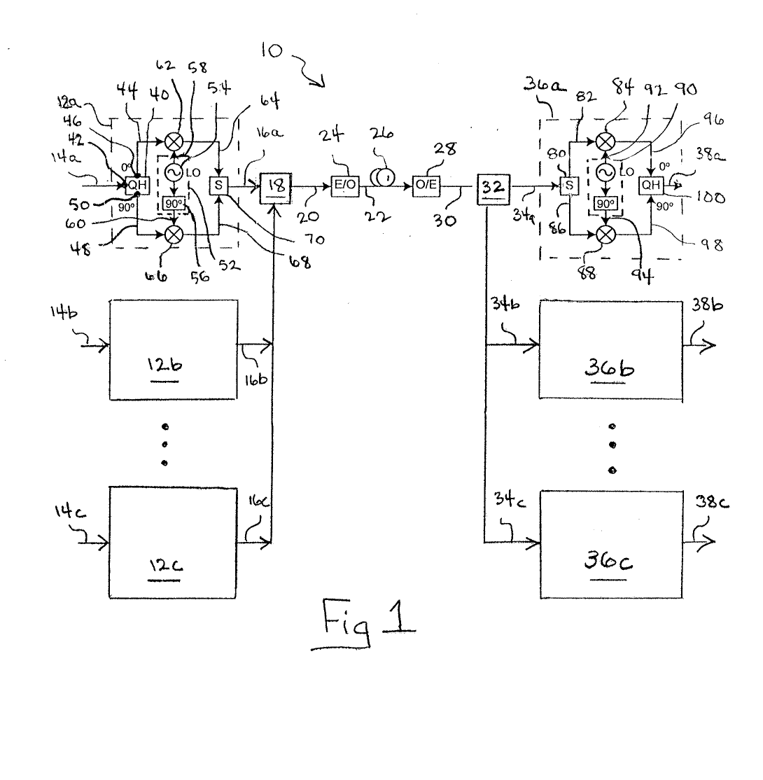

Referring initially to FIG. 1, a system for transporting signals is shown and is generally designated 10. As shown, the system 10 includes a plurality of transmitters 12a-c, with each transmitter receiving relatively low-frequency information signals 14a-c (i.e. a baseband input). For the system 10 shown, each transmitter 12a-c receives one of the relatively low-frequency information signals 14a-c as an input, processes the input signal, and outputs an up-shifted (i.e. relatively high frequency) signal 16a-c that has a suppressed sideband. The use of signals 16a-c having suppressed sidebands reduces transmission power requirements for the system 10. Although FIG. 1 illustrates an embodiment having three transmitters 12a-c, it is to be appreciated that more than three, and in some aspects of the present invention as few as one, transmitters 12a-c may be used in the system 10.

Continuing with FIG. 1, the up-shifted, suppressed sideband signals 16a-c output from the transmitters 12a-c are then frequency stacked at RF combiner 18 and the stacked signal 20 is converted to an optical signal 22 at electrical to optical (E/O) converter 24 for transmission over optical fiber 26. For the system 10, all of the up-shifted, suppressed sideband signals 16a-c output from the transmitters 12a-c have frequencies within a single sub-octave band of frequencies, defined as the band of frequencies between a low frequency f_{L} and a high frequency f_{H}, wherein f_{H}<2f_{L}. As indicated above, this arrangement reduces, and in some cases eliminates the adverse effects of composite second order distortions during optical transport of the stacked and converted optical signal 22.

FIG. 1 also shows that at the downstream end of the optical fiber, the system 10 can include an optical-electrical (O/E) converter 28 for receiving the optical signal 22 and converting it to an RF signal 30. A de-stacking splitter 32 is shown positioned downstream of the O/E converter 28 for frequency de-stacking the RF signal 30 into a plurality of de-stacked signals 34a-c. For the system 10, each of the de-stacked signals 34a-c corresponds to one of the recovered up-shifted, suppressed sideband signals 16a-c from the original stacked RF signal 20. Each de-stacked signal 34a-c is routed from the splitter 32 to a respective receiver 36a-c.

With further reference to FIG. 1, in functional overview, each receiver 36a-c processes one of the de-stacked signals 34a-c by downshifting the signal to output a signal 38a-c that corresponds to one of the low-frequency information signals 14a-c (i.e. a recovered signal 14a-c). As detailed further below, at each receiver 36a-c, the down-shifting can be accomplished with an additional 25 dB-35 dB of sideband suppression, resulting in a total sideband suppression for the system 10 of about 50 dB-70 dB.

The details concerning the internal components of transmitter 12a can now be explained with reference to FIG. 1. As shown there, transmitter 12a includes quadrature hybrid (QH) coupler 40 having an input 42 which receives the low-frequency information signal 14a. For the system 10, the quadrature hybrid coupler 40 processes the signal 14a as an input signal, for example, an input signal having a frequency, f₀, and outputs a first signal 44 that is in phase with the input signal 14a at a first coupler output 46 and a second signal 48 that is 90° out of phase with the input signal 14a at a second coupler output 50.

For the system 10 shown in FIG. 1, the transmitter 12a further includes a local oscillator (LO) subsystem 52 having a local oscillator 54 and ninety degree phase shifter 56. More specifically, the local oscillator subsystem 52 outputs a first LO signal 58 that is in phase with the input signal 14a and has frequency, with f₁>f₀. In addition, as shown, the local oscillator subsystem 52 outputs a second LO signal 60 having the frequency, f₁, and a phase that is 90° out of phase with the first LO signal 54, having passed through the phase shifter 56.

FIG. 1 also shows that the transmitter 12a includes a first mixer 62 that is positioned downstream of the first coupler output 46. The first mixer 62 receives and mixes the first LO signal 58 with the first signal 44 from the first coupler output 46 and outputs a first mixed signal 64 that is in phase with the input signal 14a. In addition, the transmitter 12a of the system 10 includes a second mixer 66 that is positioned downstream of the second coupler output 50. The second mixer 66 receives and mixes the second LO signal 60 and the second signal 48 from the second coupler output 50 and outputs a second mixed signal 68. With this structure, the second mixed signal 68 includes a component that is in phase with the input signal 14a and a component that is 180° out of phase with the input signal 14a. Because of the relative phases of the first mixed signal 64 and the second mixed signal 68, when these signals 64, 68 are summed at the summer 70, the out-of-phase components cancel resulting in upshifted signal 16a that is 180° out-of-phase with the input signal 14a and has a sideband that is suppressed by about 25 dB-35 dB.

For the system 10, the frequency of the signals 14a-c input to the transmitters 12a-c can vary from one transmitter to another. For example, the signal 14a input to transmitter 12a can have a frequency, f₀, and the signal 14b input to transmitter 12b can have a different frequency, f_{0,ss}, with f₀≠f_{0,ss}. In addition, the LO frequency can differ from one transmitter to another. For example, the LO frequency of transmitter 12a can be f₁, and the LO frequency of transmitter 12b can be f₂, with f₁≠f₂. As indicated above, the LO frequencies are selected such that signals 16a-c output from the transmitters 12a-c have non-overlapping frequencies that are all within a single sub-octave band of frequencies.

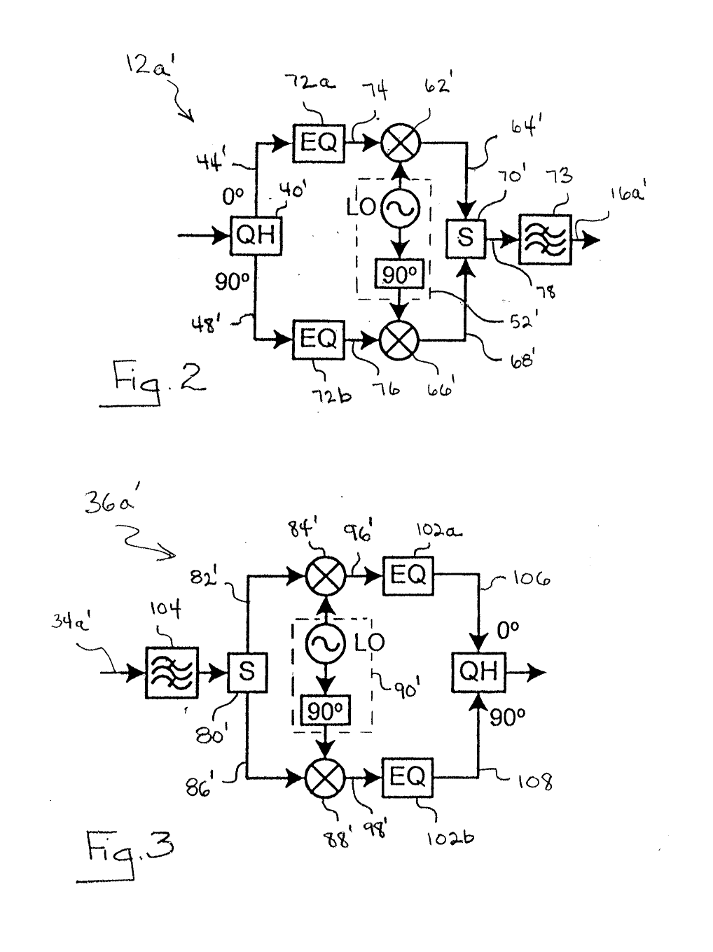

FIG. 2 shows another embodiment of a transmitter (generally designated transmitter 12a′) having equalizers 72a,b and a band pass filter 73 to increase sideband suppression. As shown, signals 44′, 48′ from the quadrature hybrid (QH) couple 40′ are directed to the equalizers 72a,b, respectively, where the amplitude and/or phase of the signals 44′, 48′ is adjusted to produce outputs signals 74, 76.

Continuing with FIG. 2, signals 74, 76 are mixed with signals from local oscillator subsystem 52′, as described above, at mixers 62′, 66′ to produce first mixed signal 64′ and second mixed signal 68′. These signals are then summed at summer 70′ to output upshifted signal 78 having a suppressed sideband. Signal 78 is then filtered by band pass filter 74 to increase sideband suppression producing filtered output signal 16a′. For example, a band pass filter passing frequencies at, above and below the LO signal frequency, f₁, can be used. Once filtered, the signal can be directed to combiner 18 (FIG. 1) for stacking with other transmission signals.

Referring back to FIG. 1, the details concerning the internal components and functions of receiver 36a can now be explained. As shown there, receiver 36a includes a splitter 80 which receives as an input the de-stacked signal 34a and outputs a first receiver signal 82 directed to a mixer 84 and a second receiver signal 86 directed to a mixer 88. FIG. 1 further shows that the receiver 36a can include a local oscillator (LO) subsystem 90 producing a first receiver LO signal 92 having frequency, f₁, that is in phase with the input signal 14a and a second receiver LO signal 94 having frequency, f₁, and phase that is 90° out of phase with the first receiver LO signal 92.

As shown in FIG. 1, signal 82 and signal 92 are mixed at mixer 84 to produce signal 96 that is in phase with the input signal 14a. Also, signal 86 and signal 94 are mixed at mixer 88 to produce signal 98 which has a phase that is 90° out of phase with the input signal 14a. Signals 96 and 98 are input into quadrature hybrid (QH) coupler 100 which processes the mixed signals 96, 98 and outputs signal 38a that corresponds to the low-frequency information signals 14a having frequency, f₀ (i.e. a recovered signal 14a). For the system 10, the down-shifting at the receiver 36a can be accomplished with an additional 25 dB-35 dB of sideband suppression, resulting in a total, system 10, sideband suppression of about 50 dB-70 dB.

FIG. 3 shows another embodiment of a receiver (generally designated transmitter 36a′) having equalizers 102a,b and a band pass filter 104 to increase sideband suppression. As shown, signal 34a′, e.g. from de-stacking splitter 32 shown in FIG. 1, is first passed through band pass filter 104 before reaching splitter 80′ to increase sideband suppression. For example, a band pass filter that passes frequencies at, above and below the LO signal frequency, f₁ can be used. Signals 82′ and 86′ from splitter 80′ are mixed with signals from the LO subsystem 90′ at mixers 84′, 88′, as described above, to produce mixed signals 96′, 98′. Continuing with FIG. 3, it can be seen that mixed signals 96′, 98′ are input to equalizers 102a,b, respectively, where the amplitude and/or phase of the signals 96′, 98′ is adjusted to produce outputs signals 106, 108, with signal 106 being in phase with the input signal 14a (FIG. 1) and signal 108 being 90° out of phase with the input signal 14a. Signals 106 and 108 are input into quadrature hybrid coupler 100′ which process the mixed signals 106, 108 and outputs signal 38a′ that corresponds to the low-frequency information signals 14a (FIG. 1) having frequency, f₀ (i.e. a recovered signal 14a).

While the particular single sideband up-down converter for sub-octave bandwidth transmission of low frequency signals and corresponding methods for use as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A system for processing an input signal having a frequency, f₀, to produce an upshifted signal having a suppressed sideband for transmission over an optical fiber, said system comprising:
a quadrature hybrid coupler receiving the input signal and outputting a first signal in phase with the input signal at a first coupler output and a second signal 90° out of phase with the input signal at a second coupler output;
a local oscillator (LO) subsystem producing a first LO signal having frequency, f₁, with f₁>f₀ and in phase with the input signal and a second (LO) signal having frequency, f₁ and 90° out of phase with the first LO signal;
a first mixer downstream of the first coupler output, the first mixer receiving the first LO signal and outputting a first mixed signal;
a second mixer downstream of the second coupler output, the second mixer receiving the second LO signal and outputting a second mixed signal; and
a summer downstream of the first mixer and second mixer for producing an upshifted, sideband suppressed signal for transmission over an optical fiber.

2. A system as recited in claim 1 wherein the input signal has a frequency, f₀, less than 5 MHz.

3. A system as recited in claim 1 further comprising a combiner downstream of the summer for frequency stacking signals, and wherein the signals being stacked all have frequencies in a sub-octave band of frequencies between a low frequency f_{L} and a high frequency f_{H}, wherein f_{H}<2f_{L}.

4. A system as recited in claim 3 wherein the combiner is an RF combiner.

5. A system as recited in claim 1 wherein the LO signal has a frequency, f₁, greater than 200 MHz.

6. A system as recited in claim 1 wherein the suppressed sideband is suppressed by greater than 25 dB.

7. A system as recited in claim 1 further comprising an equalizer downstream of the first coupler output for adjusting an amplitude and phase of the first signal to increase sideband suppression.

8. A system as recited in claim 1 further comprising a band pass filter downstream of the summer to increase sideband suppression.

9. A system as recited in claim 8 further wherein the band pass filter passes frequencies at, above and below the LO signal frequency, f₁.

10. A system as recited in claim 1 further comprising an electrical-optical converter for converting the upshifted, sideband suppressed signal to an optical signal for transmission over an optical fiber.

11. A system comprising:
a quadrature hybrid coupler receiving an input signal having a frequency, f₀, and outputting a first signal in phase with the input signal at a first coupler output and a second signal 90° out of phase with the input signal at a second coupler output;
a local oscillator (LO) subsystem producing a first LO signal having frequency, f₁, with f₁>f₀ and in phase with the input signal and a second (LO) signal having frequency, f₁ and 90° out of phase with the first LO signal;
a first mixer downstream of the first coupler output, the first mixer receiving the first LO signal and outputting a first mixed signal;
a second mixer downstream of the second coupler output, the second mixer receiving the second LO signal and outputting a second mixed signal; and
a summer downstream of the first mixer and second mixer for producing a first transmission signal;
a source of a second transmission signal; and
a combiner for frequency stacking the first transmission signal and the second transmission signal, and wherein the first transmission signal and the second transmission signal have frequencies in a sub-octave band of frequencies between a low frequency f_{L} and a high frequency f_{H}, wherein f_{H}<2f_{L}.

12. A system as recited in claim 11 further comprising:
an electrical-optical converter downstream of the combiner for generating an optical signal for transmission over an optical fiber;
an optical-electrical (O/E) converter downstream of the optical fiber to generate an RF signal from a received optical signal;
a de-stacking splitter downstream of the O/E converter for frequency de-stacking the first transmission signal from the second transmission signal; and
a receiver downstream of the de-stacking splitter for processing the de-stacked first transmission signal and recovering the input signal having a frequency, f₀.

13. A system as recited in claim 12 wherein the receiver comprises:
a receiver splitter receiving the de-stacked first transmission signal and outputting a first receiver signal portion and a second receiver signal portion;
a receiver local oscillator (LO) subsystem producing a first receiver LO signal having frequency, f₁, and in phase with the input signal and a second receiver LO signal having frequency, f₁, 90° out of phase with the first receiver LO signal;
a first receiver mixer downstream of the receiver splitter, the first receiver mixer receiving the first receiver LO signal and the first receiver signal portion and outputting a first receiver mixed signal;
a second receiver mixer downstream of the receiver splitter, the second receiver mixer receiving the second receiver LO signal and the second receiver signal portion and outputting a second receiver mixed signal; and
a quadrature hybrid coupler downstream of the first receiver mixer and second receiver mixer for outputting a recovered input signal having a frequency, f₀.

14. A system as recited in claim 11 wherein the source of a second transmission signal comprises:
a second-source quadrature hybrid coupler receiving a second-source input signal having a frequency, f_{0,ss}, and outputting a first, second-source signal in phase with the second-source input signal at a first second-source coupler output and a second, second-source signal 90° out of phase with the second-source input signal at a second, second-source coupler output;
a second-source local oscillator (LO) subsystem producing a first, second-source LO signal having frequency, f_{1,ss}, with f_{1,ss}>f_{0,ss} and in phase with the second-source input signal and a second, second-source LO signal having frequency, f_{1,ss}, 90° out of phase with the second-source LO signal;
a first, second-source mixer downstream of the first, second-source coupler output, the first, second-source mixer receiving the first, second-source LO signal and outputting a first, second-source mixed signal;
a second, second-source mixer downstream of the second, second-source coupler output, the second, second-source mixer receiving the second, second-source LO signal and outputting a second, second-source mixed signal; and
a second-source summer downstream of the first, second-source mixer and second, second-source mixer for producing the second transmission signal.

15. A system as recited in claim 11 wherein the input signal has a frequency, f₀, less than 5 MHz.

16. A system as recited in claim 11 wherein the LO signal has a frequency, f₁, greater than 200 MHz.

17. A system as recited in claim 11 further comprising an equalizer downstream of the first coupler output for adjusting an amplitude and phase of the first signal to increase sideband suppression.

18. A system as recited in claim 11 further comprising a band pass filter downstream of the summer to increase sideband suppression.

19. A method for processing an input signal having a frequency, f₀, to produce an upshifted signal having a suppressed sideband for transmission over an optical fiber, said method comprising the steps of:
receiving the input signal at a quadrature hybrid coupler and outputting a first signal in phase with the input signal at a first coupler output and a second signal 90° out of phase with the input signal at a second coupler output;
producing a first local oscillator (LO) signal having frequency, f₁, with f₁>f₀ and in phase with the input signal and a second (LO) signal having frequency, f₁ and 90° out of phase with the first LO signal;
receiving the first LO signal at a first mixer downstream of the first coupler output, and outputting a first mixed signal;
receiving the second LO signal at a second mixer downstream of the second coupler output, and outputting a second mixed signal; and
summing signals downstream of the first mixer and second mixer to output an upshifted, sideband suppressed signal.

20. The method as recited in claim 19 further comprising the steps of:
adjusting an amplitude and phase of the first signal downstream of the first coupler output to increase sideband suppression; and
band pass filtering a signal downstream of the summer to increase sideband suppression.
